(19) United States
(12) Patent Application Publication
(10) Pub. No.: US 2020/0104878 A1
(43) Pub. Date: Apr. 2, 2020

(54) SYSTEM AND METHOD FOR GENERATING TARGETED ADS BASED ON USER GENERATED CONTENT

(71) Applicant: Monday.com Ltd., Tel Aviv (IL)

(72) Inventors: Roy MANN, Tel Aviv (IL); Eran Zinman, Tel Aviv (IL)

(73) Assignee: Monday.com Ltd., Tel Aviv (IL)

(21) Appl. No.: 16/584,097

(22) Filed: Sep. 26, 2019

Related U.S. Application Data
(60) Provisional application No. 62/737,133, filed on Sep. 27, 2018.

(51) Int. Cl. G06Q 30/02

(52) U.S. Cl. CPC G06Q 30/0255; G06Q 30/0276

(57) ABSTRACT

A system and method for generating advertisements based on matching user metadata, including: associating a user generated content (UGC) with creator metadata and content metadata, wherein at least a portion of the UGC is generated by a first user associated with the creator metadata, wherein the creator metadata is based on information received from a user device of the creator and content metadata is based on the UGC; generating an advertisement based on the creator metadata and the content metadata; accessing user metadata associated with a second user; generating a match score between the user metadata and the creator metadata; matching between the user metadata and the creator metadata when the match score exceeds a predetermined threshold; and causing the generated advertisement to be displayed on a matching second user device associated with the second user.

### CROSS-REFERENCE TO RELATED APPLICATIONS

This application claims the benefit of U.S. Provisional Application No. 62/737,133 filed on Sep. 27, 2018, the contents of which are hereby incorporated by reference.

### TECHNICAL FIELD

The present disclosure relates generally to automated online advertisement generation and particularly to improving conversion rates thereof.

### BACKGROUND

Software based services have become an ever-growing market, offering many diverse services over a variety of platforms. There are multiple avenues through which a software publisher can seek to monetize such services. One popular method of monetization is known as a “freemium” model where customers are divided into two or more tiers. Non-paying service subscribers (i.e., users of the “free” service) receive a basic service that may offer fewer features than a full service, often called a “premium” service, may have additional advertisements incorporated therein, and the like. An alternative model involves offering the full service for a limited time period, after which the service ceases to be functional unless a user subscribes to it. The transition of a user subscribing to a higher-tiered service from a lower-tiered service is known as a “conversion.”

A higher conversion rate is often a primary goal and a driving force behind business growth of a service provider. Accordingly, service providers are increasingly seeking solutions that maximize conversion rates of customers, which can be a difficult task, as each user is unique and is not necessarily successfully incentivized to perform a conversion the same way as another user might be. Customizing incentives to suit each individual user can prove to be difficult and, if achievable, time consuming.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for generating advertisements based on matching user metadata, including: associating a user generated content (UGC) with creator metadata and content metadata, wherein at least a portion of the UGC is generated by a first user associated with the creator metadata, wherein the creator metadata is based on information received from a user device of the creator and content metadata is based on the UGC; generating an advertisement based on the creator metadata and the content metadata; accessing user metadata associated with a second user; generating a match score between the user metadata and the creator metadata; matching between the user metadata and the creator metadata when the match score exceeds a predetermined threshold; and causing the generated advertisement to be displayed on a matching second user device associated with the second user.

Certain embodiments disclosed herein also include a non-transitory computer readable medium having stored thereon instructions for causing a processing circuitry to perform a process, the process including: associating a user generated content (UGC) with creator metadata and content metadata, wherein at least a portion of the UGC is generated by a first user associated with the creator metadata, wherein the creator metadata is based on information received from a user device of the creator and content metadata is based on the UGC; generating an advertisement based on the creator metadata and the content metadata; accessing user metadata associated with a second user; generating a match score between the user metadata and the creator metadata; matching between the user metadata and the creator metadata when the match score exceeds a predetermined threshold; and causing the generated advertisement to be displayed on a matching second user device associated with the second user.

Certain embodiments disclosed herein also include a system for generating advertisements based on matching user metadata, including: a processing circuitry; and a memory, the memory containing instructions that, when executed by the processing circuitry, configure the system to: associate a user generated content (UGC) with creator metadata and content metadata, wherein at least a portion of the UGC is generated by a first user associated with the creator metadata, wherein the creator metadata is based on information received from a user device of the creator and content metadata is based on the UGC; generate an advertisement based on the creator metadata and the content metadata; access user metadata associated with a second user; generate a match score between the user metadata and the creator metadata; match between the user metadata and the creator metadata when the match score exceeds a predetermined threshold; and cause the generated advertisement to be displayed on a matching second user device associated with the second user.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram according to various disclosed embodiments.

FIG. 2 is a schematic illustration of matching user generated content from a first user to a second user according to an embodiment.

FIG. 3 is an example flowchart of a method for generating targeted ads based on user generated content.

FIG. 4 is a block diagram of a service server system implemented according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for using user-based content for increasing traffic, engagement, and conversion rates for an online service. In an embodiment, a server is configured to store a user generated content (UGC) generated by a creator and generates content metadata for the same. The server associates the first UGC with the content metadata based on the UGC, as well as with creator metadata that is based on information received from a user device of the creator. User metadata which is received from a second user device is matched to the creator metadata and an advertisement is sent based on the UGC to a user device associated with the user metadata, in response to the match score exceeding a first threshold.

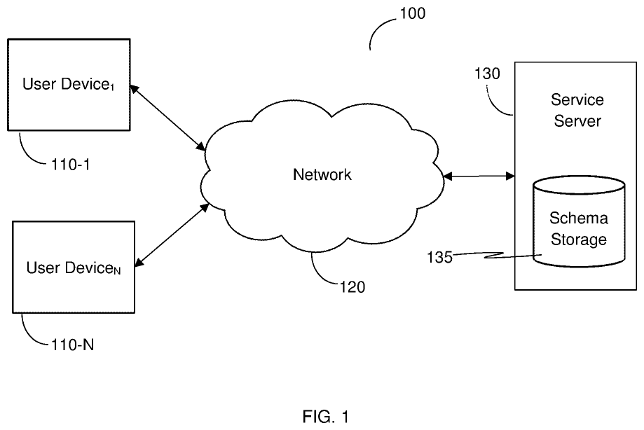

FIG. 1 is an example network diagram 100 utilized to describe the disclosed embodiments. As illustrated in Fig.,1 user devices 110-1 through 110-N, where N is an integer equal to or greater than 2, (hereinafter referred to individually as a user device 110 and collectively as user devices 110, merely for simplicity) are connected to a network 120. Each of the user devices 110 may be connected to the network 120 through a wired or wireless connection. A service server 130 is also connected to network 120.

A user device 110 may be, but is not limited to, a personal computing device, such as a computer, a tablet, a mobile phone, a wearable computing device, or any other device capable of sending and receiving data. In an embodiment, the network 120 may be configured to provide connectivity of various sorts as may be necessary, including but not limited to, wired and/or wireless connectivity, such as a local area network (LAN), wide area network (WAN), metro area network (MAN), worldwide web (WWW), Internet, and any combination thereof, as well as cellular connectivity.

The network 120 further provides connectivity to the service server 130. In an embodiment, the service server 130 is configured to provide a software-based service, such as email, enterprise resource planning (ERP), customer relationship management (CRM), task management, and the like. In some embodiments, the service server 130 is also configured to provide content over the network 120, such as audio, video, and the like.

In certain embodiments, the service server 130 may provide both a software-based service and content. For example, the service server 130 may offer a CRM service, and additionally provide schemas to be used on top of the CRM service. A schema may be, for example, a table data structure. The table data structure may be row or column based. In an example, the table data structure includes a plurality of columns, each column corresponding to a different data type. A data type may be a general alphanumeric field or may be defined more specifically, such as a date, a phone number, first name, last name, status, salary, and so on.

The service server 130 may include a storage for storing user generated content, e.g., received over the network 120. In this exemplary embodiment, the service server allows users, through a user device, to generate schemas that are stored in a schema storage 135. In an embodiment, the schema storage 135 is used to store other user generated content (UGC). It should be understood that while a single service server 130 is mentioned here, a service may be provided by a plurality of servers, for example where the plurality of service servers may be deployed in a cloud computing platform. That is, services provided by one or service servers 130 may be offered in Software as a Service (SaaS) format.

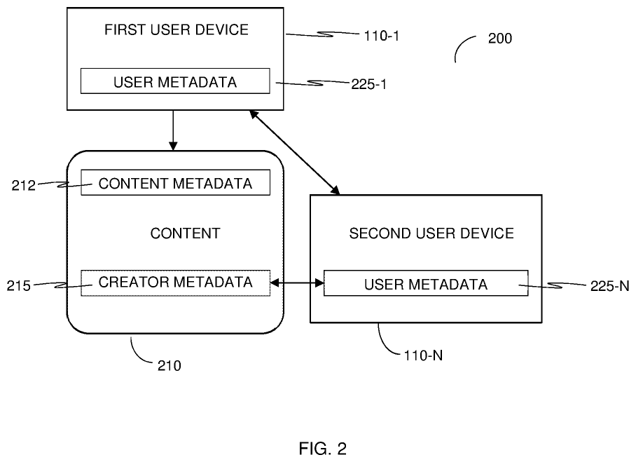

FIG. 2 is an example schematic illustration 200 of matching user generated content from a first user to a second user according to an embodiment. A first user device 110-1, associated with a first user, is used to generate a content 210, e.g., user generated content. The first user device 110-1 includes a first user metadata 225-1 that corresponds to a user of the first user device 110-1. The content 210 may be, for example, a schema, data structure, video, audio, and the like. The content 210 includes content metadata 212 and creator metadata 215. Content metadata is generated based on the content, for example by the service server 130 of FIG. 1.

In an embodiment, content metadata includes tags and may be generated based on a table header, e.g., where the tags match the table header values. For example, if a table data structure includes a first column titled ‘first_name’, a second column titled last_name', and a third column titled ‘email’, the service server may generate content metadata, e.g., tags, corresponding to ‘first_name’, last_name', and ‘email’.

In an embodiment, creator metadata 215 is embedded within the content and is received from a user device, such as the first user device 110-1, or is generated by the service server 130. For example, creator metadata 215 may be generated by the service server 130 based on a user account associated with the first user device 110-1, the first user device 110-1 type, an IP address associated with the first user device 110-1, the first user metadata 225-1, and the like. A user account may be associated with one or more user attributes, such as a username, an email address, an age group, a profession, a title, an educational level, a location, interests, and so on. The creator metadata 215 is associated with the first user device 110-1.

A second user device 110-N is associated with a second user and corresponding second user metadata 225-N. A match is determined between the second user metadata 225-N and either the first user metadata 225-1 or the creator metadata 215, e.g., by a service server. In an embodiment, the first user or the creator are associated with a tier which is higher than the second user. By determining that there is a match between the first user and second user, an advertisement generated for the first user can be targeted to the second user or second user device 110-N. By using an advertisement generated for a first user, based on user created content, to target a matching second user, there is an increased probability that the second user will interact with the generated advertisement without requiring the generation of a new advertisement specifically for that user, thereby increasing the conversion of users to the service provided by the service server without requiring additional advertisement generation. In an embodiment, an advertisement may be generated for the second user based on content generated by the first user. Thus, by showing the second user how a first user is utilizing a system, where the first user is similar (based on the match) to the second user, there is an increased likelihood that the second user will realize a benefit to using the system, thereby potentially increasing the conversion rate.

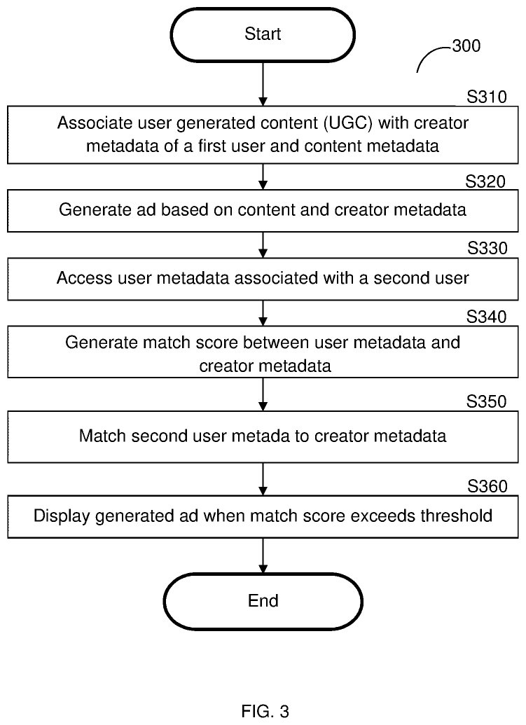

FIG. 3 is an example flowchart 300 of a method for generating targeted advertainments based on user generated content.

At S310, UGC from a first user device is associated with creator metadata. The UGC is content generated at least partially by a first user and may be generated on the first user device and stored on a service server, on the first user device, or on a combination thereof. The content may include video, audio, text, hypertext, multimedia, and any combination thereof. The creator metadata may be generated based on the first user, e.g., based on a user account associated with the first user device, the user device type, an IP address associated with the user device, the user attributes, and the like, as detailed above in FIG. 2. In an embodiment, a plurality of users may create a single UGC, and in such embodiments, the creator metadata may include metadata based on any, or all, of these users or associated user accounts.

In an embodiment, content metadata is additionally generated based on the UGC. Content metadata may be generated by analyzing, for example, content text and extracting keywords, using methods known in the art. In other embodiments, where the content is an image or picture, various image recognition techniques can be used to extract keywords, context, and the like from the same, using, for example, neural networks. In another example, content may be a data structure, such as a single data-type columnar table, and metadata may be extracted from textual elements, such as headers, identifiers, and the like.

At S320, an advertisement is generated based on the content metadata and the creator metadata. The advertisement is generated such that it is optimized to be most effective to users associated with the creator metadata and with users that generate similar UGC with the content metadata. Such an optimization may include generating an advertisement showing use of a product by a first user, e.g., for arranging tasks by due dates.

At S330, a second user metadata is accessed, e.g., from a second user device. The second user metadata of the second user device pertains to a user, “a second user,” who is not the creator of the UGC. In an embodiment, the second user metadata is accessed from a user account associated with a second user device and stored on a server external to the second user device.

At S340, a match score is generated between the user metadata of the second user and the creator metadata. The match score is a numeric value or equivalent measurement indicating the similarity between the user metadata and the creator metadata. In an embodiment, the match score additionally accounts for the content metadata as well. The match score may be generated by comparing the attributes of the creator metadata to the user metadata and determining how many attributes have a direct match, or a match within a predetermined threshold. For example, a direct match may be determined if both the user metadata and the creator metadata include a user age of 35, and a match within a predetermined threshold may be determined if the user ages included in each metadata are no more than 10 years apart. In a further example, if the creator metadata indicates that the user is an attorney, and the user metadata also indicates that the second user is an attorney, a direct match may be determined to exist.

At S350, a match is made when it is determined that the match score exceeds a threshold, and only if the threshold is exceeded, execution continues at S360. Otherwise, execution continues at S340 by generating a match score between the second user metadata and another creator metadata, or by generating a match score between a third user metadata and the creator metadata. Exceeding the threshold may include matching a minimum number of user attributes from the user metadata match the creator metadata, e.g., matching at least an age group and a location may be deemed sufficient to exceed the threshold.

At S360, the generated advertisement is caused to be displayed on the second user device. In certain embodiments, a notification may be sent, e.g., to a server, to display the advertisement. By displaying the advertisement targeted at a user who shares user attributes with the content creator, it may increase the likelihood the user will interact with the advertisement. An advertisement generated specifically for a first user, e.g., based on relevant metadata, is likely effective for other users deemed to be sufficiently similar, thereby increasing conversion rates for the advertisement. Using content metadata of content known to be created by a first user in order to generate the advertisement further increased the likelihood of a second, sufficiently similar, user to engage with the advertisement. The second user device may include a smartphone, a tablet, a personal computer, and the like.

In an example embodiment, a first attorney uploads a video showing how they use a webapp for managing legal due dates. Based on the creator metadata and content metadata associated with the video, it is determined to relate to attorneys, legal deadlines, and related categories. A match is made to a second attorney having matching metadata associated therewith. An advertisement is generated to be displayed on a device used by the second attorney, which may display the video, or a portion thereof, and state: “See what people like you are using the webapp for.” If, for example, the first attorney is using premium features of the webapp and the second attorney is currently only using a free version of the webap with limited functionality, the advertisement displays a relevant use of the premium features to the second attorney, and thus there is a greater likelihood that the second attorney would convert from a free user to a premium one based on this advertisement compared to a generic advertisement.

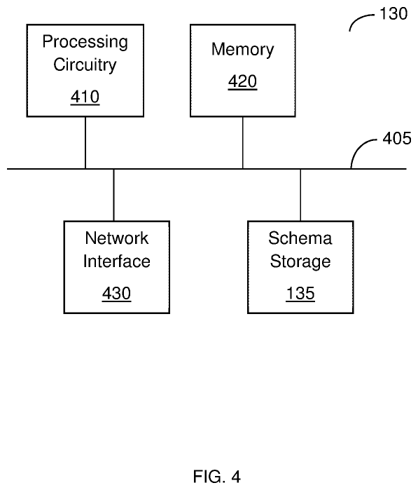

FIG. 4 is an example schematic illustration of a service server 130 implemented according to an embodiment. The service server 130 includes at least one processing circuitry 410, for example, a central processing unit (CPU). In an embodiment, the processing circuitry 410 may be, or be a component of, a larger processing unit implemented with one or more processors.

The processing circuitry 410 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The processing circuitry 410 is coupled via a bus 405 to a memory 420. The memory 420 may include a memory portion 422 that contains instructions that, when executed by the processing circuitry 410 performs the method described in more detail herein. The memory 120 may be further used as a working scratch pad for the processing circuitry 410, a temporary storage, and others, as the case may be. The memory 420 may be a volatile memory such as, but not limited to random access memory (RAM), or non-volatile memory (NVM), such as, but not limited to, flash memory.

The processing circuitry 410 may be coupled to a network interface card 430 for providing connectivity, for example to network 120 of FIG. 1. The processing circuitry 410 may be further coupled with a schema storage 135, shown in FIG. 1. The schema storage 135 may be used for the purpose of holding a copy of the method executed in accordance with the disclosed technique. The schema storage 135 may further be used for storing schemas, user generated content, and the like.

The processing circuitry 410 and/or the memory 420 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 410 to perform the various functions described in further detail herein in FIG. 3.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating advertisements based on matching user metadata, comprising:
associating a user generated content (UGC) with creator metadata and content metadata, wherein at least a portion of the UGC is generated by a first user associated with the creator metadata, wherein the creator metadata is based on information received from a user device of the creator and content metadata is based on the UGC;
generating an advertisement based on the creator metadata and the content metadata;
accessing user metadata associated with a second user;
generating a match score between the user metadata and the creator metadata;
matching between the user metadata and the creator metadata when the match score exceeds a predetermined threshold; and
causing the generated advertisement to be displayed on a matching second user device associated with the second user.

2. The method of claim 1, wherein the match score is further generated based on the content metadata.

3. The method of claim 1, wherein the UGC is any of: video, audio, text, hypertext, multimedia, and any combination thereof.

4. The method of claim 1, wherein the creator metadata is based on at least one of:
a username, an email address, an age group, a profession, a title, an educational level, a location, and interests.

5. The method of claim 1, further comprising:
generating the content metadata, wherein the content metadata is generated by analyzing the UGC to extract keywords.

6. The method of claim 5, wherein analyzing the UGC includes image recognition.

7. The method of claim 1, wherein the match score is a numeric value indicating a similarity between the user metadata and the creator metadata.

8. The method of claim 1, where the match score additionally accounts for the content metadata.

9. The method of claim 1, wherein the threshold is exceeded when a minimum number of user attributes match between the user metadata match the creator metadata.

10. A non-transitory computer readable medium having stored thereon instructions for causing a processing circuitry to perform a process, the process comprising:
associating a user generated content (UGC) with creator metadata and content metadata, wherein at least a portion of the UGC is generated by a first user associated with the creator metadata, wherein the creator metadata is based on information received from a user device of the creator and content metadata is based on the UGC;
generating an advertisement based on the creator metadata and the content metadata;
accessing user metadata associated with a second user;
generating a match score between the user metadata and the creator metadata;
matching between the user metadata and the creator metadata when the match score exceeds a predetermined threshold; and
causing the generated advertisement to be displayed on a matching second user device associated with the second user.

11. A system for generating advertisements based on matching user metadata, comprising:
a processing circuitry; and
a memory, the memory containing instructions that, when executed by the processing circuitry, configure the system to:
associate a user generated content (UGC) with creator metadata and content metadata, wherein at least a portion of the UGC is generated by a first user associated with the creator metadata, wherein the creator metadata is based on information received from a user device of the creator and content metadata is based on the UGC;
generate an advertisement based on the creator metadata and the content metadata;
access user metadata associated with a second user;
generate a match score between the user metadata and the creator metadata;
match between the user metadata and the creator metadata when the match score exceeds a predetermined threshold; and
cause the generated advertisement to be displayed on a matching second user device associated with the second user.

12. The system of claim 11, wherein the match score is further generated based on the content metadata.

13. The system of claim 11, wherein the UGC is any of: video, audio, text, hypertext, multimedia, and any combination thereof.

14. The system of claim 11, wherein the creator metadata is based on at least one of:
a username, an email address, an age group, a profession, a title, an educational level, a location, and interests.

15. The system of claim 11, wherein the system is further configured to:
generate the content metadata, wherein the content metadata is generated by analyzing the UGC to extract keywords.

16. The system of claim 15, wherein analyzing the UGC includes image recognition.

17. The system of claim 11, wherein the match score is a numeric value indicating a similarity between the user metadata and the creator metadata.

18. The system of claim 11, where the match score additionally accounts for the content metadata.

19. The system of claim 11, wherein the threshold is exceeded when a minimum number of user attributes match between the user metadata match the creator metadata.
